(19) United States
(12) Patent Application Publication
(10) Pub. No.: US 2007/0214156 A1
(43) Pub. Date: Sep. 13, 2007

(54) WHOLE FARM ASSURANCE AND ACTUARIAL SYSTEM

(75) Inventors: Martin James Barker, Burton upon Trent (GB); James Thomas Leavesley, Burton upon Trent (GB); John William Leavesley, Burton upon Trent (GB)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: GENESIS QUALITY ASSURANCE LIMITED, Burton upon Trent (GB)

(21) Appl. No.: 11/749,486

(22) Filed: May 16, 2007

Related U.S. Application Data
(62) Division of application No. 10/183,939, filed on Jun. 26, 2002.

(51) Int. Cl. G06F 17/00

(52) U.S. Cl. 707/100

(57) ABSTRACT

This whole farm assurance and actuarial system is a multi-enterprise certification system that undertakes a modular approach, which allows farms to obtain certification for different enterprises without the need for duplication of inspections or administration. This system includes a plurality of assurance procedures separated into modules. A first module of procedures is applicable to farm independent criteria for meeting requirements of a farm regardless of the type of farm. A second module of procedures is applicable to enterprise-specific criteria for meeting requirements of a first enterprise type, and a third module of procedures applicable to enterprise-specific criteria for meeting requirements of a second enterprise type. The farm is required to comply with requirements of the first module before the farm can be certified for either of the second or third modules. In another embodiment, the system includes additional modules of procedures applicable to enterprise-specific criteria for meeting requirements of a respective enterprise type. Exemplary systems may also include a module of procedures for collection of insurance risk assessment data used for assessing the risk of a predetermined insurable event at the farm.

### FIELD OF THE INVENTION

This invention relates to assurance systems, and more particularly to certification schemes for farm production and to farm assurance data for insurance risk assessment.

### BACKGROUND OF THE INVENTION

Farm assurance schemes impose certifiable standards upon food and farm producers that are independently checked against a quality inspection regime (e.g., the United Kingdom Accreditation Service (UKAS), the European Normative Standard for Product Certification Systems (EN 45011), the International Standards Organization (ISO), Standard for Product Certification Systems ISO Guide 65, etc.). Farm assurance schemes exist for separate farming enterprises including arable, produce, poultry, dairy and livestock (e.g., pig, beef, sheep). Legislation sets minimum production standards and assurance schemes encourage good practice and the continual raising of standards.

Each set of standards defines the essential elements of good farm practice and establishes criteria which must be achieved before any enterprise (e.g., arable, produce, poultry, dairy, and livestock, such as beef, sheep and pig) may be certified as being compliant with the standard. Standards are set in conjunction with a committee of technical advisors (Technical Advisory Board) with reference to legislative requirements, codes of good practice, and the requirements and expectations of major purchasers and other interested parties with regard to food safety, environmental and animal welfare values, legislation and best industry practice. Proposed standards are subject to a wide consultation process with external bodies related to the industry.

In order to establish the criteria for the relevant enterprise standards, assurance schemes establish: how each criterion should be assessed by an inspector; what should be adjudged as a pass or fail; and the necessary action that should be taken in the event that a criterion requirement is not met (e.g. that corrective action be taken by the applicant in an agreed time frame, the temporary suspension of certification, or the complete withdrawal of certification depending on the severity of any failure). In other words, inspections generally use either a rating system of scores or a basis of minor and major nonconformance criteria.

Inspection assessors are typically independent of any industry interest and assess the applicant business's compliance with the scheme's standards only. Subsequent decisions to Certify the business, or not, are taken by separate Certification personnel under the control of the Certification Board. Typically, assessment inspections and related fees take place periodically.

In accordance with the requirements of a product certification regime, for example, EN 45011, the standard typically establishes documented processes and procedures by which all applications to join a farm assurance scheme are handled. The procedures typically include a right to appeal an unfavorable decision. All inspections are undertaken by trained and independent auditors or inspectors, who report their findings to personnel acting under the auspices of a product certification regime accredited certification board. The certification board retains the overall authority to grant, refuse or rescind a certificate of conformity.

Participation in a farm assurance scheme is generally voluntary. However, consumer demand drives concerns as to food safety and production methods, and retailers may impose the need for producers to be certified to an assured standard. In other words, it is common that major buyers of farm produce do not consider purchasing raw material from farmers who are not certified members of an assurance scheme accredited by the quality inspection regime. Purchasers use the schemes as part of their own procurement strategies as a means of demonstrating due diligence in relation to food safety matters and also as a means of providing consumers with reassurances about environmental and animal welfare considerations.

Accredited certification bodies are subject to scrutiny and inspection by the relevant accreditation body. For example, in the United Kingdom (UK), certification bodies are subject to scrutiny and inspection by the United Kingdom Accreditation Service (UKAS), which is the UK government appointed authority for the assessment and accreditation of certification bodies. Other farm assurance schemes have been established by individual sectors of the industry (e.g., representative industry bodies from the pig, poultry, beef, sheep and dairy sectors), and are operational in the United Kingdom. However, it would be beneficial to offer a single multi-enterprise assurance scheme for all of the farm enterprises. Such a cross-sector approach could develop into a modular system of farm assurance, by which farms of all types and enterprises could become certified via a common system using a unified inspection regime.

### SUMMARY OF THE INVENTION

In an exemplary embodiment, a multi-enterprise certification system allows farms to obtain certification for different enterprises without the need for duplication of inspection or administration. This system includes a plurality of assurance procedures separated into modules. A first module of procedures is applicable to farm independent criteria for meeting requirements of all farms regardless of the type of farm enterprise. A second module of procedures is applicable to first enterprise specific criteria for meeting requirements of a first enterprise type, and a third module of procedures is applicable to second enterprise specific criteria for meeting requirements of a second enterprise type. Any farm seeking certification must comply with the requirements of the first module in order for the farm to be certified by either of the second or third modules.

The multi-enterprise certification system may also include a fourth module of procedures for the collection of insurance risk assessment data used for assessing the risk of a predetermined insurable event.

In another exemplary embodiment of the invention, a method for allowing farms to obtain certification for different enterprises without the need for duplication of inspections or administration is provided. The method includes assessing farm independent criteria using a first module of procedures for meeting requirements of any farm regardless of the type of farm enterprise, assessing first enterprise specific criteria using a second module of procedures different than the first module of procedures for meeting requirements of a first enterprise type, and assessing second enterprise specific criteria using a third module of procedures different than the first or second module of procedures for meeting requirements of a second enterprise type, and determining that the farm complied with the requirements of the first module before the farm can be certified as meeting the requirements of either the second or third module.

The method may also include collecting insurance risk assessment data for assessing the risk of a predetermined insurable event.

In yet another exemplary embodiment of the invention, a multi-enterprise certification system is provided. The system allows farms to obtain certification for different enterprises without the need for duplication of inspections or administration. The system includes means for assessing farm independent criteria using the first module of criteria for meeting requirements of a farm having at least a first enterprise type and a second enterprise type, means for assessing first enterprise specific criteria using a second module of procedures different than the first module of procedures for meeting requirements of the first enterprise type, means for assessing second enterprise specific criteria using a third module of procedures different than the first or second module of procedures for meeting requirements of the second enterprise type, and means for determining that the farm complies with the requirements of the first module before the farm can be certified as meeting the requirements of either the second or third module.

In one example of this exemplary embodiment, this system also includes means for collecting insurance risk assessment data used for assessing the risk of a predetermined insurable event.

Further scope of applicability of the present invention will become apparent in the description given hereafter. However, it should be understood that the detailed description and specific examples, while indicating preferred embodiments of the invention, are given by way of illustration only, since the invention will become apparent to those skilled in the art from this detailed description.

### BRIEF DESCRIPTION OF THE DRAWINGS

The invention will be described in conjunction with the following drawings, in which like-referenced numerals designate like-elements, and wherein:

FIG. 1 is an exemplary whole farm assurance and actuarial system in accordance with a preferred embodiment of the invention;

FIG. 2 is a flowchart illustrating an exemplary use of the whole farm assurance and actuarial system in accordance with a preferred embodiment of the invention; and

FIG. 3 is a flowchart illustrating an exemplary use of inspection/audit procedures for a whole farm assurance and actuarial system in accordance with a preferred embodiment of the invention.

### DETAILED DESCRIPTION OF THE INVENTION

Without being limited to a particular theory, the present invention is directed to a unique system of farm assurance in which multiple enterprise units (e.g., a combination of different types of enterprises such as combinable crops with dairy production or pigs with poultry) can join a single scheme without the need for duplication of inspections or administration. In this system, farming standards are divided into separate modules. A first module covers criteria that are applicable to farms of all types, regardless of the type of enterprise (e.g., requirements in relation to safety procedures, farm records, staff employment and training). Other modules are specific to individual enterprise types (e.g., pigs, poultry, beef, sheep, dairy, combinable crops, etc.).

This system uses a modular approach which allows a farming producer to be assessed for each of his or her farming enterprises without the need to join separate schemes relating to, and to be inspected for, each individual farming sector. The system also includes a module with procedures for providing actuarial information for insurance evaluation, as will be described in greater detail below.

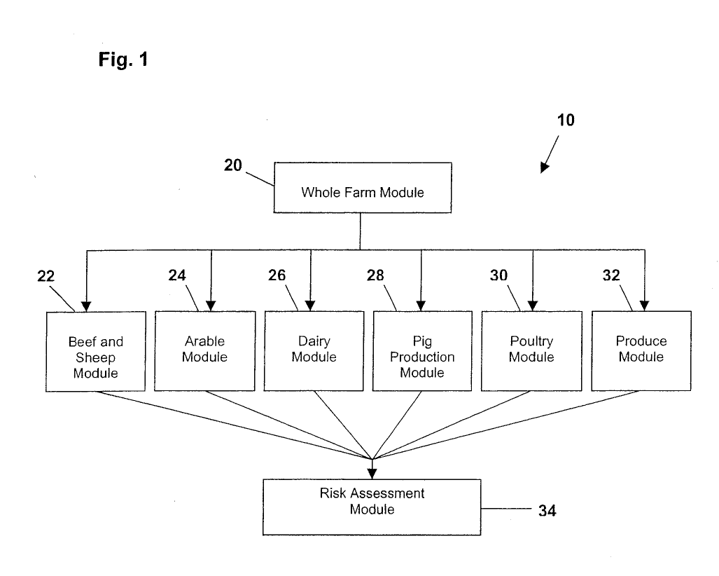

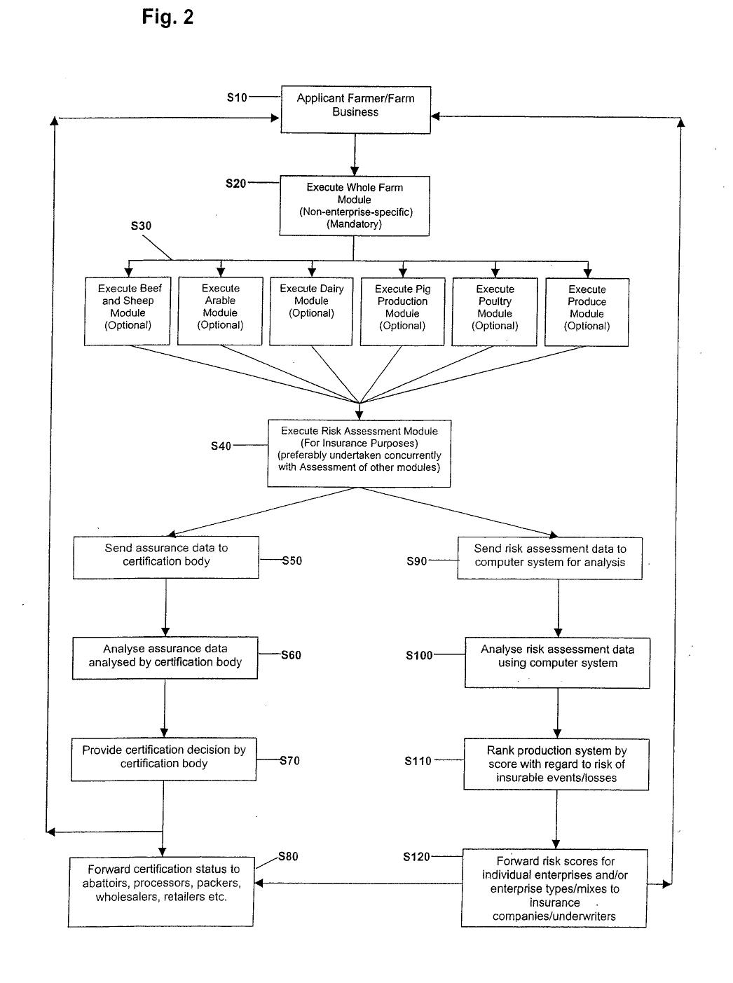

Referring to FIGS. 1 and 2, an exemplary multi-enterprise whole farm assurance and actuarial system is schematically illustrated at 10. The exemplary system 10 includes a plurality of modules (e.g., Whole Farm Module 20, Beef and Sheep Module 22, Arable Module 24, Dairy Module 26, Pig Production Module 28, Poultry Module 30, and Produce Module 32). The modules are executable at steps S20 and S30 of FIG. 1. Each module includes procedures applicable to criteria for meeting predetermined requirements of a farm. Without being limited to a particular theory, this system 10 preferably also includes a Risk Assessment Module 34 of procedures executable at step S40 for the collection of data used for assessing the risk of a predetermined insurable event.

The Whole Farm Module 20 includes procedures covering criteria that are applicable to farms of all types, regardless of the type of enterprise. Exemplary requirements for this module may include, but not be limited to requirements in relation to safety procedures, farm records, staff employment, and training.

As an example of requirements for this module, regarding safety procedures, the farm must have a current Control of Substances Hazardous to Health policy and a current Health and Safety policy. The farm must have clearly displayed plans for fire and accident procedures and location of telephone, main switches for electricity, and water and fire extinguishers.

Regarding exemplary codes of practice, the production unit of the farm must have copies of the relevant codes of practice corresponding to the enterprises operated by the production unit. For example, all production units must have good agricultural practice for the protection of air, soil and water, and industry regulated codes of practice for the control of salmonella during the storage, handling and transport of raw materials.

Regarding the staff, for example, records must be maintained of the relevant training and experience, and certificates of competence or other qualification details must be held. Regarding professional advisors and registrations, all farms with livestock enterprises must have a named veterinarian surgeon or practice. Moreover, any farm applying pesticides to crops or grassland must have a named qualified agronomist, and all home-mixers of feeding stuffs must be registered with or approved by the relevant authority.

Regarding health plans, for example, all farms with livestock should have a veterinary health plan, and all farms should have a waste management plan, chemical spillage plan, and pest control plan. Moreover, for example, all farms with livestock enterprises must maintain a movement record as required by legislation, and all bovine must be individually identified with relevant cattle passports available. All farms must maintain up to date medicine purchase and administration records, including, for example, records of veterinary medicines purchased, dates administered, identity of animal treated, dated administered, quantity of medicine used, and name of the person who administered the medicine. Similar records must be maintained for crop and feed, as used by the farm or business.

Still referring to FIGS. 1 and 2, modules 22-32 include assurance procedures applicable to specific criteria for meeting requirements of an enterprise type. Examples of an enterprise type include, but are not limited to arable cropping, pig production, poultry production, dairy production, beef and sheep production, or produce. The set of standards for each enterprise type are specific to the respective individual enterprise type.

In other words, the modules 22-32 include procedures applicable to specific criteria for meeting requirements of different enterprise types. For example, one of the specific criteria modules 22-32 could be designated as a first enterprise type, and another one of the specific criteria modules 22-32 could be designated as a second enterprise type module, based on the enterprises available at a specific farm.

Exemplary criteria required under the beef and sheep module are set forth below. In addition to the whole farm module, beef and sheep must be identifiable and traceable. In particular, the farm of birth of sheep must be identifiable, store animals, breeding stock, lambs and cows must be brought from a farm registered under a recognized assurance scheme, or alternatively, animals must be kept on a farm for minimal periods before slaughter.

Regarding farm animal management for beef and sheep, animals must be treated and handled in such a way to avoid injury and minimize stress, all animals must have access to sufficient clean water, and any treatment that involves a surgical operation to any animal must be carried out by a competent stockman or veterinarian. Regarding environment and hygiene management, all chemicals must be disposed of safely at all times, precautions must be taken to minimize loose animals contaminating each other during transport, and each breeding, rearing or feeding unit should be equipped with suitable facilities to isolate sick or injured animals. Regarding feed composition, guides must not contain any fishmeal or any product of mammalian or avian origin with the exception of dairy products.

Regarding housing and handling facilities, housing must be of sufficient size, allowing appropriate stocking densities allowing ventilation to assure a clean and hygienic condition. During daylight hours, the level of indoor lighting (natural or artificial) must be such that all housed stock can be seen clearly and inspected. All stock must have a dry, well-drained lying area that is cleaned regularly and thoroughly. In addition, all electrical installations should be inaccessible to stock, protected and properly grounded.

Exemplary specific criteria required for the arable module are set forth below. Regarding pesticides, all operators of spraying equipment must hold a relevant certificate of competence. All pesticides must be clearly labeled, and kept in its original packaging when not in use. All pesticide label recommendations must be adhered to including maximum permitted dose rates, restrictions on repeated applications to a single crop, harvest intervals and latest application stage. A copy of a data sheet from all the different pesticides used on the farm must be kept with the assessment.

Regarding fertilizers and nutrients, the application of untreated sewage sludge to combinable crops is not permitted. Moreover, soil analysis for major nutrients must be undertaken at least every four to five years to insure fertilizer application effectiveness.

Regarding crop stores, long term stores must be of sound construction and weatherproof, have solid floors, have solid walls that prevent a risk of contaminating crops, have all possible entry points for birds, vermin and domestic animals suitably blocked, and have secured loading pipes. Moreover, doors and windows must be well fitted. Short-term stores must be of sound construction and weatherproof, have leak-proof roofs and have solid floors and walls that prevent a risk of crop contamination. The application of untreated, digested or advanced treated sludge to agricultural land must be in accordance with industry regulations and codes of practice for the agricultural use of sewage sludge.

Exemplary criteria for meeting requirements of a dairy module are set forth below. All dairy animals must undergo regular veterinary inspections with records of the inspections maintained. A herd health plan is required that preferably shows routine preventive treatments.

Regarding cows, tethering is not permitted except for group-housed calves feeding, but only so for one hour. Calves must not be muzzled and must be able to see at least one other calf. Housed calves must be inspected twice daily and outdoor calves inspected once daily.

Regarding milking, lactating cows should be milked on a regular basis. The milking parlors should have non-slip floors and be designed and constructed to minimize the risk of injury to cows. Milking equipment should not cause injury, pain or discomfort to the cows.

Regarding medicines, the farm must have a procedure for identifying cattle that have received medical treatments. Regarding facilities, all housing must be adequately ventilated and well drained. All housing must have lighting to insure the cattle can be visually inspected and must have floor surfaces constructed and maintained to minimize the risk of cows slipping. All housing must have a non-slatted lying area, must allow animals to see and hear other animals unless segregated for calving, treatment of illness or injury. In addition, all housing should be designed to minimize drafts and exposure to extreme temperature or weather, should be designed and constructed to safeguard against injury or distress to cattle, and should allow bulls to be able to see, hear and smell other cattle.

There must be at least one cubicle per cow, unless there is adjacent, accessible and adequate size loose housing. The design of the cubicle housing should allow cows to exhibit normal behavior, especially when lying, ruminating and rising. The bedding used must provide a dry, comfortable surface to lie on, and the cleanliness of the bedding must be checked daily.

Regarding group yards, an adequate loafing area must be provided having sound, non-slip floors. The design of yards or loose housing systems must allow sufficient space for all cows to lie down simultaneously, ruminate and rise without difficulty. Cows due to calve should be inspected at least twice a day. Calving areas must have clean bedding that is an adequate depth to allow for calving and allow the cow to rise safely and to minimize the risk of infection to both cow and calf. The calving areas must be equipped with good lighting to allow for close inspection.

All cattle should have sufficient access to trough space and must have free access to sufficient clean, fresh drinking water. Calves must receive colostrum within six hours of birth and must be fed at least twice a day on a wholesome diet appropriate to their age, weight and species. The dairy must be kept clean and tidy, must have a closeable door separating the dairy from a milking parlor, must have external doors which are locked at night or when the farm is unattended, and must have hand-washing and drying facilities and waste bins.

Prior to milking, udders must be cleaned and dried. Running water for cleaning dirty cows, milking machines and floors during milking must be available. Cows having milk unfit for human consumption must be clearly identified and must be milked last or with a separate bucket or system.

Exemplary criteria for meeting requirements of a pig enterprise type are set forth below. All newly purchased or replacement-breeding females must be homozygous negative for halothane. All breeding stock entering the boundary of a production unit shall be quarantined in order to identify signs of illness.

The internal structure and fittings of structures that house or contain pigs shall be designed and constructed to not allow pigs to be injured or distressed by the projection of sharp objects and to be cleaned and disinfected to the extent necessary to prevent the spread of disease. Pig housing shall provide secure pig containment. Pigs shall not be kept in permanent darkness, but be allowed access to either natural or artificial light equivalent to the period of light normally available between 0900 and 1700 hours each day. Light shall be of a sufficient intensity to allow newspaper print to be read. Hospital isolation pens shall be available to house sick pigs. The use of stalls, tethers or electric goads is not permitted.

The farm shall have a written plan to insure that staff understands the actions to be taken in the event of fire, loss of utilities, or topical emergencies. Power supplies and electrical installations shall be inaccessible to pigs.

Pigs kept in open yards or loose housing systems shall be thermally comfortable. Dry sows shall be free to lie down, turn around and move around without difficulty. Floors shall be either solid dry area, half-solid area with slatted dunging area, or full slats.

A supply of clean, fresh water shall be available to all pigs each day. For weaned pigs, two drinking places, if of a nipple or bowl type shall be available in every pen. Regarding feed, trough space and restricted feed systems shall be sufficient to allow all pigs in the pen to feed at the same time. In loose housed systems, individual cells shall have sufficient space to allow pigs access to food, as well as the opportunity to escape the feed area and avoid other sows (and/or production only).

Products of animal or avian origin other than fishmeal and milk products, shall not be included in the diet. Fishmeal shall not be fed to pigs within 14 days of dispatch for slaughter. Swill may not be fed. Feed shall be stored in conditions that do not allow or cause cross contamination, loss of feed product, identity, ingress of water, foreign matter contamination, or direct access by pests. The farm must have a veterinary health plan drawn up and regularly updated by the attending veterinary surgeon.

Without being limited to a particular theory, it is understood that the exemplary criteria listed above for the modules represents some criteria that may be used in determining certification of a farm. The criteria does not represent a complete set of the criteria required. Instead, the lists are examples of some criteria that may be inspected during an assessment.

FIG. 2 is a diagrammatic representation of an exemplary use of the whole farm assurance and actuarial system. The system can be used by any farmer or farming business that is able to comply with the requirements of the certifiable standards, as described above, for example, in the Background section. At step S10, the applicant farmer or business, upon application or request, is provided with a copy of the scheme standards. The applicant is responsible for reading the standard documents and ensuring that the applicant believes the farm or business is compliant with the requirements of the standard.

The Whole Farm Assurance and Actuarial (WFAA) system offers a unique modular approach to whole-farm assurance. Under this system, all applicant businesses must comply with the “whole-farm module” of the scheme that incorporates criteria that must be satisfied by all farms to meet the requirements identified by the standard. In addition, the applicant must also decide which enterprises should be investigated for certification, based on the relevancy of each enterprise to the farmer's business.

Having decided which modules are required, the applicant's business can be assessed against the whole-farm module at step S20 and against enterprise specific modules (e.g., beef and sheep module, arable module, dairy module, etc.) at step S30. Assessing the applicant's business against the whole-farm module is mandatory, however the applicant may choose to be assessed against any combination of enterprise specific modules. As a minimum, the applicant is preferably assessed against at least one of the enterprise specific modules.

Regardless of which enterprise specific modules have been selected, concurrent with the farm assurance inspection/audit, the business is also preferably assessed against a risk assessment module at step S40. The risk assessment module covers the criteria identified by the Technical Advisory Board as relevant to the probability of certain predetermined insurable events occurring in or on the premises of the applicant business.

All inspections/audits are undertaken by independent, trained and qualified personnel, as described in greater detail below. Results of the inspection/audit for farm assurance purposes are forwarded to the accredited certification body at step S50 where they are analyzed in accordance with the scheme procedures at step S60. A decision is made by the certification body at step S70 with regard to the compliance of the applicant to the requirements of the standards. The applicant is notified of the decision of the certification body and, where relevant, a certificate of conformity is awarded. Any certificate of conformity will specify which modules of the scheme have been satisfied, albeit that no applicant will be awarded a certificate of conformity without satisfying the requirements of the whole-farm module at step S20 and at least one enterprise specific module at step S30. The findings of the certification body can also be made available, upon request, to other interested parties at step S80.

Data from the risk assessment module executed at step S40 can be used at step S90 for analysis by computer at step S100. The actuarial system facilitates the ranking or scoring of individual farms and/or types of production systems/enterprise in relation to specified and identified risks or events at step S110, and as described in greater detail below. Such scores and/or rankings may then be forwarded to insurers and underwriters at step S120, who may choose to use such data in formulating insurance premiums and tailoring insurance products to particular markets or to individual farm businesses. Such information may also be used to tailor insurance products to other interested parties with regard to food safety and/or permit such interested parties to assess the level of risk associated with their own procurement chains.

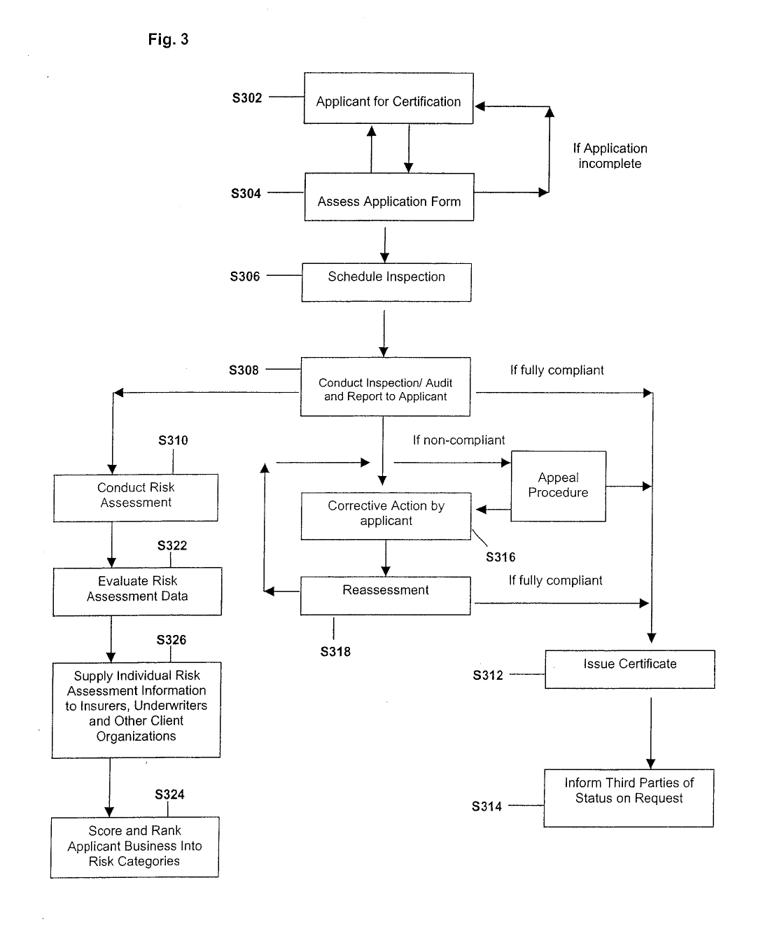

The system outlined by FIGS. 1 and 2 include modules for a plurality of different types of enterprises. The exemplary embodiment shown in FIG. 1 includes 6 different types of farm enterprise modules which may be combined in any combination within any given individual farm business however, the process as described, for example in FIG. 2, would be equally applicable to other enterprise types incorporated as additional modules. It is understood that the number of enterprises in the multi-enterprise certification system must be at least two (although the system can also be used for a single enterprise business), but can be any number greater than two, depending on the number of enterprises, where each enterprise is a different type of farm product. In other words, as shown in FIG. 1, modules 22-32 include procedures applicable to criteria for meeting requirements of an enterprise type other than a designated first or second enterprise type. For example, if the first enterprise is pigs, and the second enterprise is produce, then the third enterprise applicable may be, for example, dairy. Under such a scenario, modules 22-32 would all be applicable. As discussed above, the multi-enterprise certification system includes modules for any number of different enterprise types. FIG. 3 illustrates an exemplary use of inspection and audit procedures in accordance with a preferred embodiment of the invention. At step S302, an applicant (e.g., farmer) applies for certification in at least one enterprise type (e.g., beef and sheep, arable, dairy, etc.).

The application is assessed for completeness at step S304. If the application is incomplete, it is returned to the applicant for correction and resubmission. Otherwise, an inspection is scheduled with the applicant at step S306.

At step S308, an inspector conducts an inspection/audit against the requirements of the relevant standards and, if desired, concurrently conducts an insurance risk assessment at step S310. The insurance risk assessment conducted at step S310 will be discussed in greater detail below.

If the information obtained during the inspection conducted at step S306 indicates that the inspected business complies with the requirements of the relevant standard, then the information is forwarded to a certificate issuing body, such as a product certification regime accredited certification board. As discussed above, this certification board retains the overall authority to grant, refuse or rescind a certificate of conformity. In this instance where the business complies with the requirement of the standard, the certification board arranges for a certificate of conformity to be issued to the applicant at step S312. In addition, the certification status, but not the information on which a decision has been made, may be made available to interested third parties on request at step S314. Such third parties may include, among others: farmers, abattoirs, food processing companies, and retailers.

In the event that the applicant's business does not comply with the requirements of the relevant standard, the inspector suggests a course of remedial action and a time scale for the applicant to provide the necessary corrective actions. These suggestions are forwarded to the accredited certification board, which determines whether or not a certificate of conformity should be awarded. Regardless of whether a certificate is awarded or not, the applicant is subject to provide the corrective action, at step S316, for reassessment of the non-compliant elements at a later date by a certified instructor, at step S318. If after reassessment, the business is still not compliant, then the applicant may provide further corrective or remedial action, although the certification board may look unfavorably on the failure to undertake the prior suggested corrective action following the first inspection. Should the applicant disagree with the findings of the inspector, or with the decision of the certification board, then the applicant may appeal via a formalized appeal procedure at step S320.

As noted above, preferably during the first inspection of the applicant's business, the inspector concurrently conducts a risk assessment of the business at step S310. Data from the assessment is evaluated at step S322. Based on the evaluation of the risk assessment data, the applicant's business is given a score and ranked into a risk category at step S324. The risk assessment information is also provided to insurers, underwriters or other client organizations as required or desired at step S326.

As can be readily understood by a skilled artisan, farmers are thus able to sign up for the set of modules that best suits their particular farm, rather than having to join a variety of different schemes. All farms must comply with the requirements of the whole farm module 20 in order for other enterprise-specific modules 22-32 to be certified. Provided the farm or business meets the requirements of the whole farm module 20, it is possible to achieve the required standard in relation to one enterprise, and therefore be certified for that enterprise, while being refused certification for another enterprise if the specified standards were not achieved. For example, a farm could be certified for pigs and arable, but not for sheep. If a farm meets the requirements for the whole farm module 20, but fails to meet the requirements of a specific enterprise type, then future timely inspections may only need to be limited to the criteria for the specific enterprise, and not for the whole farm module 20. Accordingly, this system provides yet another unique and cost effective mechanism for the delivery of product certification systems to farmers.

Still referring to FIGS. 1 and 2, Module 34 includes procedures for the collection of insurance risk assessment data used for assessing the risk of a predetermined insurable event. That is, in addition to information collected as part of the farm assurance inspection, the inspector can also collect information that can be used to help assess the risk of various insurable events. Such insurance risk assessment data preferably relates, for example, to the risk of fire, animal disease, contamination of food products, pollution events, residues of veterinary medicines, etc. The module includes a series of indicators that can be scored and used in an overall assessment of risk in relation to particular events. For example, the information collected could include: the location of the farm; the age, quality and design of the buildings; the type of systems operated (e.g. whether intensive or extensive; livestock housing systems using straw or slurry; controlled environment buildings, loose housing or open yards); the amounts of animal medicines and crop protection products used; the proximity of food storage areas on the farm to known hazards such as fuel storage facilities, chemical stores or animal waste and/or fertilizer storage; and the qualifications and experience of personnel working at the farm.

This type of information allows the enterprises to be assessed and scored for insurance purposes, as shown at steps S322 and S324 of FIG. 3. This type of information is valued by insurers and underwriters, as it allows them to make more informed assessments of risk, thus permitting insurance premiums to be priced competitively and marketably. It also allows the prospect of a wider range of insurance being offered to cover risks that have herethereto been considered uninsurable by both farmers and insurers (e.g. direct and consequential losses caused by some diseases; failure to achieve quality criteria or market specifications).

A computer system is preferably used to determine a risk assessment score based on the insurance information. The computer system includes a special purpose computer arranged to calculate the risk assessment score from the insurance information. The risk assessment score is based upon quality assurance standards preferably produced in the country and field of application by a Technical Advisory Committee (TAC). The quality assurance standards typically reflect the statutory legislation and best-practiced methods of production and safety. The standards are translated into a list used to provide risk assessment data and evaluate the data. For example, Table 1 shows an exemplary assessment form from which a farm or business can be given a risk score and rank.

TABLE 1
Risk Assessment Form

| | | Non | | | | | | |
|---|---|---|---|---|---|---|---|---|
| Question | Conform | Conform | Fire | Flood | Disease | Pollution | Security | TOTAL |
| Does the site have a | Yes | | 8 | 0 | 9 | 4 | 8 | 29 |
| visitor policy | | | | | | | | |
| Are staff trained | | No | (10) | (7) | (6) | (8) | (5) | (36) |
| Is the site secure | Yes | | 10 | 5 | 10 | 4 | 10 | 39 |
| Are pesticides used | | No | (4) | (9) | (6) | (10) | (3) | (32) |
| correctly | | | | | | | | |
| Is paint stored correctly | Yes | | 6 | 1 | 1 | 10 | 2 | 20 |
| TOTAL | | | 10 | (10) | 8 | 0 | 12 | 20 |

The risk assessment form includes questions or requirements used to ascertain the business's risk score. Each question can be answered “yes” if the business conforms to or affirms the question. The business does not conform to the question if the farm does not meet the question. For example, the farm investigated in Table 1 has a visitor policy, is secure and stores its paint correctly. However, the farm does not train its staff nor correctly use its pesticides.

The columns in the table list areas of concern relating to the risk. Such areas include, for example, the risk of fire, flood, disease, pollution, and security. Other areas can be added, such as welfare, food safety, environment, etc. The columns are ranked for each question according to its importance for a corresponding question. For example, incorrectly stored paint is critical from a pollution standpoint, but is not critical for flood, disease or security dangers. In addition, whether a site or farm is secure is very important for the risk of fire, disease, or security, but is not as important for flood or pollution. Accordingly, each column is ranked in respect to the comparable harm or importance for conformance or non-conformance of a corresponding question.

If a farm does conform to a question, then the numbers in its row are added to provide a total representing the relative value for conforming to that question. Likewise, a farm that does not conform to a question, has its number subtracted. Accordingly, as shown in the Table, the numbers are added for the row having the question of whether the site has a visitor policy, whether the site is secure, and whether the paint is stored correctly. However, the numbers are subtracted for the numbers corresponding to whether the staff is trained and whether pesticides are used correctly. The column totals are calculated to produce a score, e.g., a score of 10 for fire and negative 10 for flood. These numbers indicate that the farm is relatively safe for fire, but not for a flood.

In addition, any non-conforming numbers above a certain threshold, for example, 7, are listed for a report indicating suggested areas of action to be addressed. In Table 1, for example, this feature would be used to provide a report stating the need to train staff to especially lower the risk for fire and pollution. The report could also provide a projected savings on insurance premiums that would be achieved by such measures, as calculated in accordance with insurance industry standards.

By providing the combination of farm assurance inspection and insurance risk assessment, the multi-enterprise whole farm and actuarial system 10 provides the benefits of: permitting assurance certification to farmers at a lower cost; providing insurers and underwriters with a cost-effective mechanism for collecting risk assessment information; allowing insurance companies to offer more affordable insurance premiums to farmers considered to be in lower risk categories; and presenting opportunities for a wider range of specific risk to be insured.

Without being limited to a particular theory, the system 10 provides unique and valuable information to a variety of potential users, including, but not limited to, insurers and underwriters; farmers as a means of assessing and improving their farms; government and associated agencies as a mechanism for assessing and improving farm practices in relation to food safety and other business risk; and other elements of the food supply chain as a means of assessing the suitability of suppliers and as part of due diligence procedures. For example, in order to ensure the safety of the food a retailer supplies to its customers, the retailer may choose to procure stocks of certain products from suppliers which have been assessed as having a low risk of food contamination or the incidence of any given disease. Similarly, such a retailer may choose to procure supplies from particular enterprise types that have been assessed, by virtue of their design and operation, as requiring lower inputs of medicines or pesticides. In this way primary and secondary processors, pack houses and other suppliers to the retailer which are aware of these requirements will be able to select farmer suppliers which are able to satisfy the retailers aspirations and/or risk specifications. Conversely groups of farmers might also seek to differentiate their product in the overall market by drawing attention to the favorable risk assessment data in relation to their own outputs or in relation to particular production systems.

It should be apparent from the aforementioned description and attached drawings that the concept of the present application may be readily applied to a variety of preferred embodiments, including the exemplary embodiments disclosed herein. Without further elaboration, the foregoing will so fully illustrate the invention that other may, by applying current or future knowledge, readily adapt the same for use under various conditions of service.

1. A multi-enterprise certification system allowing farms to obtain certification for different enterprises without the need for duplication of inspections or administration, the system comprising a plurality of assurance procedures separated into modules, a first module of procedures applicable to farm independent criteria for meeting requirements of a farm having at least a first enterprise type and a second enterprise type, a second module of procedures applicable to first enterprise specific criteria for meeting requirements of a first enterprise type, and a third module of procedures applicable to second enterprise specific criteria for meeting requirements of a second enterprise type, wherein any one of the farms is required to comply with the requirements of said first module before the one farm can be certified for either of said second or third modules.

2. The system of claim 1, wherein certification of said second module is independent of certification of said third module.

3. The system of claim 1, wherein certification of said third module is independent of certification of said second module.

4. The system of claim 1, further comprising a fourth module of procedures for the collection of insurance risk assessment data used for assessing the risk of a predetermined insurable event.

5-14. (canceled)
